(19) United States
(12) Patent Application Publication
(10) Pub. No.: US 2019/0310485 A1
(43) Pub. Date: Oct. 10, 2019

(54) THREE-DIMENSIONAL DISPLAYS OF OBJECTS IN THREE-DIMENSIONAL SPACE

(71) Applicant: Gal ROTEM, Petach Tikva (IL)

(72) Inventor: Gal ROTEM, Petach Tikva (IL)

(21) Appl. No.: 16/294,949

(22) Filed: Mar. 7, 2019

Related U.S. Application Data
(60) Provisional application No. 62/654,560, filed on Apr. 9, 2018.

(51) Int. Cl. G02B 27/22; G06T 7/50; H04N 13/39; H01Q 3/30

(52) U.S. Cl. CPC G02B 27/2278; H01Q 3/30; H04N 13/39; G06T 7/50

(57) ABSTRACT

A storage vessel retains a quantity of a compound. The compound has molecules that emit photons in response to stimulation by one or more beams of energy. A beam emitter assembly has a plurality of beam emitters. Each beam emitter selectively and controllably emits directional beams of energy toward the storage vessel. A control and processing subsystem selectively actuates the beam emitters in groups of at least two beam emitters. For each group, the beam emitters in the group emit directional beams of energy that converge at a convergence point in the storage vessel. The converging energy beams induce molecules located at the convergence point to emit photons.

### CROSS-REFERENCE TO RELATED APPLICATIONS

This application claims priority from U.S. Provisional Patent Application No. 62/654,560, filed Apr. 9, 2018, whose disclosure is incorporated by reference in its entirety herein.

### TECHNICAL FIELD

The present invention relates to light based displays of objects.

### BACKGROUND OF THE INVENTION

Holograms are images that give the appearance of being three-dimensional, and allow an observer to view an object, produced by a holographic process, as a pseudo three-dimensional object with the naked eye. Holograms are generated by encoding light fields from objects on a holographic recording medium, such as photographic glass plates or silver halide photographic emulsion film, as an interference pattern. Under suitable lighting conditions, the encoded interference pattern diffracts the light to reproduce the original light fields, which allow the objects. Pseudo holograms utilize simpler recording mediums, for example, canvas, glass or water, to produce holographic effects.

Other methods for displaying objects having the appearance of being three-dimensional or being in three-dimensional space utilize an illumination element (e.g., light bulb) mounted to a rotating component that rotates at speeds which render the rotating component nearly invisible to the human eye, thereby creating the illusion of one or more points of light (generated by the illumination element) hovering or floating in free space.

### SUMMARY OF THE INVENTION

The present invention is directed to systems and methods for generating three-dimensional displays of objects in three-dimensional free space.

According to the teachings of an embodiment of the present invention, there is provided a system. The system comprises: at least one storage vessel for retaining a quantity of at least one compound having molecules that emit photons in response to stimulation by one or more beams of energy; a beam emitting assembly having a plurality of beam emitters, each beam emitter of the plurality of beam emitters being configured to selectively and controllably emit directional beams of energy toward the at least one storage vessel; and a control and processing subsystem including at least one processor configured to: selectively actuate the plurality of beam emitters in groups of at least two beam emitters, for each group, the directional beams of energy emitted by the beam emitters in the group converge at a corresponding convergence point within the at least one storage vessel so as to induce photon emission by one or more molecules of the at least one compound located at the convergence point.

Optionally, the plurality of beam emitters is implemented as a plurality of radiation sources that emit directional beams of electromagnetic radiation in one or more wavelengths of the electromagnetic spectrum.

Optionally, for each group, the directional beams of electromagnetic radiation emitted by the radiation sources in the group constructively interfere with each other at the convergence point.

Optionally, each group consists of exactly two beam emitters.

Optionally, each group includes a first beam emitter and a second beam emitter, and the directional beams of energy emitted by the first and second beam emitters are substantially orthogonal to each other.

Optionally, for each group, each of the directional beams of energy emitted by the beam emitters of the group has an associated spatially variant energy, and for all points other than the convergence point, the energy of each of the directional beams of energy emitted by the beam emitters of the group has a fractional amount of the energy required to induce photon emission by the one or more molecules.

Optionally, for each group, the directional beams of energy emitted by the beam emitters of the group has an associated spatially variant energy, and at the convergence point, the combined energy of the directional beams of energy emitted by the beam emitters of the group is greater than or equal to the energy required to induce photon emission by the one or more molecules.

Optionally, the control and processing subsystem is further configured to actuate the beam emitting assembly in accordance with pixel information extracted from a three-dimensional image.

Optionally, the control and processing subsystem is configured to receive the three-dimensional image from an image modeling system that generates three-dimensional images.

Optionally, the at least one storage vessel includes at least one grid having a plurality of grid elements, and each respective beam emitter of the plurality of beam emitters is associated with a respective grid element of the plurality of grid elements.

Optionally, the convergence point corresponds to a spatial intersection of projections of at least two of the grid elements, and the control and processing subsystem is further configured to selectively actuate beam emitters associated with the at least two of the grid elements.

Optionally, the control and processing subsystem is further configured to: transform pixels corresponding to a three-dimensional image into corresponding convergence points, each convergence point defined by the spatial intersection of projections of respective grid elements, and the selective actuation includes sequentially actuating groups of beam emitters according to an actuation sequence, each group in the actuation sequence corresponds to a respective convergence point.

Optionally, the at least one storage vessel is formed as polyhedron having a plurality of planar surfaces, and the at least one storage vessel includes at least a first grid that divides one of the planar surfaces into a first set of grid elements and a second grid that divides another one of the planar surfaces into a second set of grid elements.

Optionally, the at least one storage vessel has at least one curved portion having a curved surface, and the at least one storage vessel includes at least one grid that divides the curved surface into a set of grid elements.

Optionally, the at least one storage vessel is configured to retain a plurality of compounds, each compound has an emission spectrum in a different region of the electromagnetic spectrum.

Optionally, the at least one compound includes neon gas.

There is also provided according to an embodiment of the teachings of the present invention a method. The method comprises: providing a quantity of at least one compound in a storage vessel, the at least one compound having molecules that emit photons in response to stimulation by one or more beams of energy; deploying a plurality of beam emitters in spaced relation about the exterior of the storage vessel, each beam emitter of the plurality of beam emitters configured to selectively and controllably emit directional beams of energy toward the storage vessel; and selectively actuating the plurality of beam emitters in groups of at least two beam emitters, for each group, the directional beams of energy emitted by the beam emitters in the group converge at a corresponding convergence point within the storage vessel so as to induce photon emission by one or more molecules of the at least one compound located at the convergence point.

Optionally, the storage vessel includes at least one grid having a plurality of grid elements, and each respective beam emitter of the plurality of beam emitters is associated with a respective grid element of the plurality of grid elements, and the convergence point corresponds to a spatial intersection of projections of at least two of the grid elements.

Optionally, the method further comprises: receiving pixel information corresponding to a three-dimensional image; and transforming the pixel information into corresponding convergence points, each convergence point defined by the spatial intersection of projections of respective grid elements, the selective actuation includes sequentially actuating groups of beam emitters according to an actuation sequence, each group in the actuation sequence corresponds to a respective convergence point.

There is also provided according to an embodiment of the teachings of the present invention a system. The system comprises: at least one storage vessel for retaining a quantity of at least one compound having molecules that emit photons in response to stimulation by electromagnetic radiation in one or more wavelengths of the electromagnetic spectrum; a radiation source assembly having a plurality of radiation sources, each radiation source of the plurality of radiation sources being configured to selectively and controllably emit directional beams of electromagnetic radiation toward the at least one storage vessel; and a control and processing subsystem including at least one processor configured to: selectively actuate the plurality of radiation sources in groups of at least two radiation sources, for each group, the directional beams of electromagnetic radiation emitted by the radiation sources in the group constructively interfere with each other at a corresponding convergence point within the at least one storage vessel so as to induce photon emission by one or more molecules of the at least one compound located at the convergence point.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a block diagram of a system for generating three-dimensional displays of objects in three-dimensional free space, having a processing subsystem, a container module, and a radiation source assembly, according to an embodiment of the invention;

FIG. 2 is a schematic illustration of an example deployment of the system of FIG. 1, in which the container module is implemented as a cube, and in which two radiation sources of the radiation source assembly are shown, according to an embodiment of the invention;

FIG. 3 is a schematic illustration of the container module of FIG. 2 having a generalized two-dimensional grid arranged on two perpendicular surfaces of the cube, according to an embodiment of the invention;

FIG. 4 is a schematic illustration of a container module implemented as a sphere having a grid on the contiguous curved surface of the sphere; and

FIG. 5 is a flow diagram illustrating a process for generating a three-dimensional display of an object in three-dimensional free space, according to embodiments of the present disclosure.

### DESCRIPTION OF THE PREFERRED EMBODIMENTS

The present invention is directed to systems and methods for generating three-dimensional displays of objects in three-dimensional free space.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions such as, for example, top and bottom, left and right, front and rear, and the like. These directional references are exemplary only to illustrate the invention and the embodiments thereof.

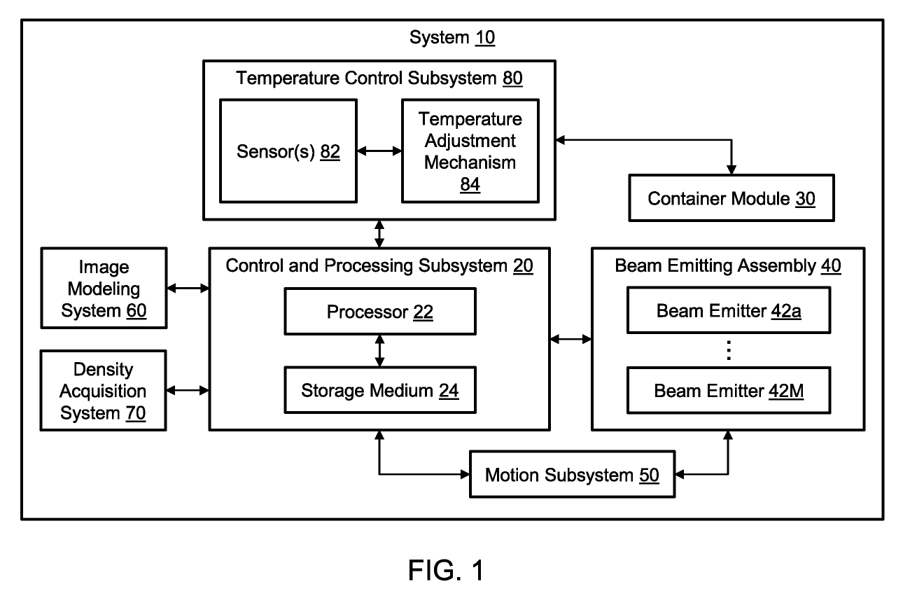

Referring now to the drawings, FIG. 1 illustrates a block diagram of a system, generally designated 10, constructed and operative according to an embodiment of the present disclosure, for generating a three-dimensional display of objects in three-dimensional free space. Generally speaking, the system 10 includes a control and processing subsystem 20, a container module 30, and a beam emitting assembly 40 that has a plurality of beam emitters 42a-42M, deployed in spaced relation about the exterior of the container module 30, for emitting beams (i.e., waves) of energy toward the container module 30. In principle, the total number of beam emitters, M, can take on any integer value greater than 1 (i.e., M≥2), but as will be discussed in greater detail below, larger values of M may yield three-dimensional displays of objects with higher density and luminous intensity.

In certain non-limiting implementations, the beam emitting assembly 40 is implemented as a radiation source assembly for emitting beams (i.e., waves) of electromagnetic radiation toward the container module 30. In other non-limiting implementations, the beam emitting assembly 40 is implemented as a charged particle emitter assembly for emitting beams of charged particles toward the container module 30.

The container module 30 is a storage vessel that can be filled with, and retain a quantity of, one or more compounds having molecules that emit photons in response to stimulation by electromagnetic radiation in one or more wavelengths at high enough energy levels, or in response to stimulation by charged particles. In certain embodiments, the container module 30 includes multiple storage vessels, which may include a plurality of physically separate (but optionally adjacent) storage vessels, or may include a main storage vessel and one or more sub-storage vessels deployed within the main storage vessel. In such embodiments, each of the storage vessels (e.g., the adjacent storage vessels, or the main storage vessel and the sub-storage vessel/vessels) may be filled with, and retain a quantity of, a respective compound having photon emitting molecules.

Certain gases, when stimulated by particular wavelengths of electromagnetic radiation at high enough energy levels, or when stimulated by charged particles, induce the emission of photons by the atoms (and therefore molecules) of the gas particles. Neon gas is an exemplary type of such a gas wherein stimulation of high energy radiation or charged particles causes electrons of the gas atoms to jump from a lower energy state to a higher energy state, thereby inducing photon emission when the electrons return to the lower energy state. Fluorescence is a particular form of photon emission in the case of stimulation by electromagnetic radiation, wherein the compound (e.g., neon gas) is sensitive to electromagnetic radiation and the electron jump between states is induced by the absorption of the electromagnetic radiation by the molecules of the compound. As an example, when the electromagnetic radiation absorbed by the compound is in the ultraviolet (UV) region of the electromagnetic spectrum (and thus is invisible to the human eye), the fluorescence (i.e., the emitted light) is in the visible light region of the electromagnetic spectrum.

For each molecule undergoing photon emission, the molecule acts as an isotropic radiator in that the light fields radiating out from the molecule are uniform in all directions over a sphere centered at the molecule. The aggregation of light fields radiating out from the molecules that undergo photon emission results in the appearance of an object, formed by light, hovering in three-dimensional free space inside the container module 30. The resultant three-dimensional light-formed object resembles that of a hologram hovering in free space. As such, throughout the remainder of this document, the generated three-dimensional displays of objects, using the methodologies according to the embodiments of the present disclosure, are referred to interchangeably as “real holograms”.

As will be discussed in more detail below, the shape of the object (i.e., the real hologram) is determined according to the specific regions/areas within the container module 30 are stimulated so as to induce photon emission by the molecules located at the specific regions/areas.

The following paragraphs describe the interaction between the beam emitting assembly 40, the container module 30, and the control and processing subsystem 20. For clarity of description of the operation of the system 10, the beam emitting assembly 40 is hereinafter described within the context of the non-limiting implementation of a radiation source assembly that has a plurality of radiation sources that emit directional beams of electromagnetic radiation in one or more wavelength bands of the electromagnetic spectrum. Accordingly, throughout the remainder of the description, the beam emitting assembly 40 is referred to interchangeably as a radiation source assembly 40, and the plurality of beam emitters 42a-42M is referred to interchangeably as a plurality of radiation sources 42a-42M. It is emphasized that reference to the beam emitting assembly as a radiation source assembly should not limit the disclosed embodiments and scope of the appended claims to such implementations.

Bearing the above in mind, each of the radiation sources 42a-42M is configured to emit beams of electromagnetic radiation, occupying one or more wavelength bands of the electromagnetic spectrum, in a directional manner toward to the container module 30. Each individual radiation source produces a directional beam of electromagnetic radiation that on its own has a fractional amount of the energy required to stimulate a gas molecule in the container module 30. As will be discussed in more detail below, in certain embodiments, pairs of beams, from two different radiation sources, are directionally emitted so as to converge (i.e., intersect) at a convergence point at which the radiation waves constructively interfere with each other, thereby producing enough energy to stimulate one or more gas molecules located at (or in the vicinity of) the convergence point to induce photon emission by the one or more molecules.

In implementations in which the beam emitting assembly is implemented as a radiation source assembly, the container module 30 may be constructed from a radiation transmissive material that transmits radiation in wavelengths emitted by the radiation sources 42a-42M without scattering effects. In a non-limiting construction, the container module 30 is constructed from glass coated with a layer of anti-reflective coating.

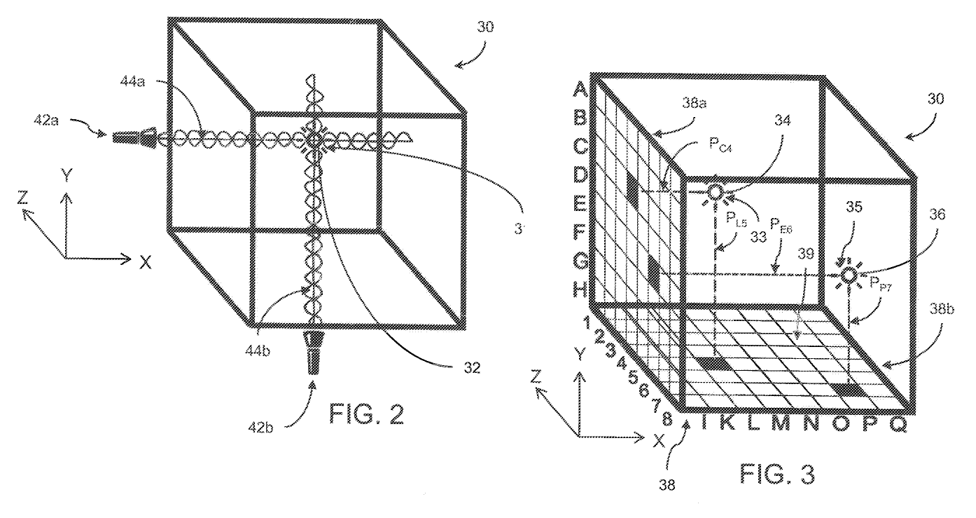

With continued reference to FIG. 1, refer now to FIG. 2, a schematic representation of the container module 30 and two individual radiation sources, namely a first radiation source 42a and a second radiation source 42b, to illustrate the photon emission induced by stimulation from electromagnetic radiation according to embodiments of the present disclosure. As is shown in FIG. 2, the first radiation source 42a emits a directional beam 44a that originates from the left side of the container module 30 and propagates horizontally to the right along the x-axis, and the second radiation source 42b emits a directional beam 44b that originates from below the container module 30 and propagates upward vertically along the y-axis.

Parenthetically, the XYZ coordinate system shown in FIGS. 2 and 3 is used for reference directions only, and should not be taken as limiting the deployment of the components of the system 10 of the present embodiments to a particular orientation.

The directional beams 44a and 44b converge at a convergence point 32, which is the point in space within the container module 30 at which the combined energy levels from the beams 44a and 44b is just high enough to induce photon emission. In other words, the beams 44a and 44b constructively interfere with each other at the convergence point 32 to produce enough energy to stimulate a gas molecule (or molecules) 31 located at the convergence point 32 to induce photon emission by the molecule (or molecules).

Note that the energy of the beams produced by the radiation sources of the radiation assembly 40 are time and spatially variant, meaning that the peak energy of the electromagnetic beam changes with respect to the instantaneous position of the beam over time. As a consequence, the directionality and energy level of the beams emitted by the radiation sources (e.g., the radiation sources 42a and 42b) are such that no molecules are stimulated by the beams prior to convergence of the beams at the convergence point (e.g., the convergence point 32). In other words, only the molecule (or molecules) located at (or in the vicinity of) the convergence point receives enough energy so as to be to induce photon emission, whereas all other molecules (within the container module 30) do not receive enough energy to be stimulated, and therefore do not induce photon emission.

As an example, consider the gas molecule 31 located at the convergence point 32 that requires radiation having energy of at least Eₚ to induce photon emission (i.e., energy threshold Eₚ). The energy produced by the first beam of the beam pair is denoted by E₁(s, t) and the energy produced by the second beam of the beam pair is denoted by E₂(s, t), where s is the instantaneous position and t denotes time. The two beams converge at the convergence point 32 (also referred to as point P) at time t=T. The combined energy from the beams at the convergence point 32 of the beams of the beam pair is denoted by E₁(P, T), and is approximately equal to E₁(P, T)+E₂(P, T), assuming that the waves constructively interfere properly at the convergence point 32. At all points before the convergence point 32, both E₁ and E₂ should be less than Eₚ/2 such that neither beam can individually stimulate any gas molecules to induce photon emission, or if the beams constructively interfere prior to the convergence point 32, the combined energy of the beams will be less than Eₚ. At the convergence point 32, both E₁ and E₂ are slightly greater than Eₚ/2 such that E is slightly greater than by Eₚ(i.e., above the energy threshold Eₚ).

Note that the directionality of the beams may be selected such that the beams in a pair of beams converge at the convergence point at a predetermined angle. In the example illustrated in FIG. 2, the two beams are orthogonal to each other (i.e., the angle between the two beams is 90°), however, other angles are possible, and may be selected according to characteristics of the compound in the container module 30 and characteristics of the radiation emitted by the radiation sources (e.g., the wavelength band of the radiation produced by the radiation sources 42a-42M).

The control and processing subsystem 20 is connected to the radiation source assembly 40 and is configured to control and selectively actuate the individual radiation sources 42a-42M to emit beams of radiation. The control and processing subsystem 20 is also configured to deactivate the individual radiation sources 42a-42M to cease emission of radiation beams. In other words, the control and processing subsystem 20 is able to selectively switch individual radiation sources “on” (i.e., actuate to emit radiation) and “off” (i.e., deactivate to cease emission) in order to generate real holograms. The selective switching is performed according to an actuation sequence, which will be discussed in further detail in subsequent sections of the present disclosure.

The control and processing subsystem 20 includes at least one processor 22 coupled to a storage medium 24, such as a memory or the like. The processor can be any number of computer processors including, but not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission devices capable of providing a processor with computer readable instructions.

By controlling and actuating the individual radiation sources, the system 10 is able to selectively stimulate molecules at selected locations (i.e., selected convergence points), thereby selectively inducing emission of photons at those selected locations. In order to reach the energy threshold required to stimulate a molecule (or molecules) at a desired convergence point, the control and processing subsystem 20 actuates individual radiation sources of the radiation source assembly 40 in groups. Each group includes at least two individual radiation sources in each group, and in certain embodiments there are exactly two individual radiation sources in each group. Accordingly, in such embodiments, the control and processing subsystem 20 actuates pairs of radiation sources in order to stimulate photon emission at selected convergence points within the container module 30.

In embodiments in which the control and processing subsystem 20 actuates pairs of radiation sources, each individual radiation source has slightly less than half of the energy required to stimulate any non-convergence point gas molecules to induce photon emission, and each individual radiation source has slightly more than half of the energy required to stimulate gas molecules at the convergence point.

As previously discussed, the energy of the beams emitted by the radiation sources of the radiation assembly 40 are time and spatially variant. Accordingly, each radiation source in the actuated group emits a beam of electromagnetic radiation having an average energy that may be a function of the position of the molecule(s) located at the corresponding convergence point. The control and processing subsystem 20 may calculate the threshold energy required to induce photon emission at the convergence point, and may subsequently adjust the average energy of the emitted beams in each actuated group according to the required threshold energy in order to ensure that the convergent beams produce enough energy to induce photon emission at the convergence point. The calculation of the threshold energy may be based on an estimation of the positions of the molecules of the compound retained within the container module 30, which in turn may be based on a measured or estimated density of the compound.

Note that in certain embodiments, the control and processing subsystem 20 actuates individual radiation sources in groups of more than two radiation sources (i.e., an N-tuples, where N>2). In such embodiments, each individual radiation source has slightly less than 1/Nth of the energy required to stimulate any non-convergence point gas molecules to induce photon emission, and each individual radiation source has slightly more than 1/Nth of the energy required to stimulate gas molecules at the convergence point.

In order to build up a real hologram according to the present embodiments, the control and processing subsystem 20 actuates the groups of individual radiation sources of the radiation source assembly 40 according to a determined actuation sequence based on a predetermined and desired shape of the objective real hologram. The sequential actuation of the individual radiation sources induces photon emission by molecules at a corresponding sequence of convergence points within the container module 30, thereby producing a real hologram (in three-dimensional space) having a generally predetermined and desired shape, from the aggregation of emitted photons. The actuation sequence, according to which the groups are actuated, may be selected according to pixel information from an image that is to be generated as a real hologram, and further in accordance with the allocation of the individual radiation sources in each group in order to ensure that individual radiation sources from different groups, if/when actuated simultaneously, do not emit beams that constructively interfere with each other at non-convergence points.

The actuation sequence may include ordering and timing information corresponding to the individual radiation sources of the radiation source assembly 40. The ordering and timing information allows the control and processing subsystem 20 to control the “on” and “of” timing of the individual radiation sources 42a-42M to produce a time dependent real hologram. The ordering and timing information includes, but is not limited to, the specific order in which the individual radiation sources of the radiation source assembly 40 are to be actuated to emit respective beams (i.e., switched “on”), the specific order in which individual radiation sources of the radiation source assembly 40 are to be deactivated to cease respective beam emission (i.e., switched “off”), and the duration over which each individual radiation source of the radiation source assembly 40 emits a respective beam when actuated. Note that the beam emission duration may be used to dictate the duration for which the real hologram is displayed, i.e., the real hologram will disappear once all individual radiation sources are switched “off” (except for trace amounts of photon emission that dissipate over time after stimulation from the individual radiation sources is stopped)

The following paragraph describes a non-limiting example of an actuation sequence for six (i.e., three pairs) individual radiation sources (i.e., radiation source 42a, radiation source 42b, radiation source 42c, radiation source 42d, radiation source 42e, and radiation source 42f). The example is for demonstration purposes in order to better convey the “on” and “of” timing controlled by the control and processing subsystem 20.

At time t₀, actuate radiation sources 42a and 42b for a duration of T₀ (i.e., switch “on” at time t₀ and switch “off” at time t₀+T₀). At time t₁<t₀+T₀, actuate radiation sources 42c and 42d for a duration of T₁ (i.e., switch “on” at time t1 and switch “off” at time t₁+T₁). At time t₂<t₁+T₁, actuate radiation sources 42e and 42f for a duration of T₂ (i.e., switch “on” at time t₂ and switch “off” at time t₂+T₂.

According to certain embodiments, the container module 30 is implemented as a polyhedron having a plurality of planar surfaces. Examples of such polyhedrons include, but are not limited to, cubes, cuboids, prisms, tetrahedrons, icosidodecahedrons, and triacontahedrons. FIG. 3 shows a non-limiting example construction of the container module 30 when implemented as one such polyhedron, namely a cube. In embodiments in which the container module 30 is formed as a polyhedron, at least two of the planar surfaces of the polyhedron has a generalized two-dimensional grid 38 that divides the two respective planar surfaces into multiple grid elements 39.

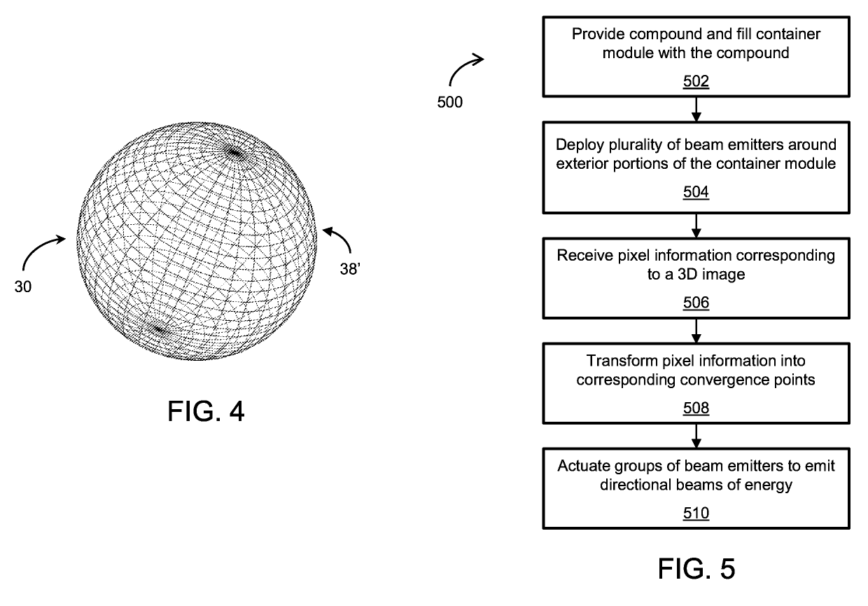

In other embodiments, the container module 30 is implemented as a three-dimensional structure that has a contiguous curved surface. Examples of such curved three-dimensional structures include, but are not limited to, spheres and ovoids. In such embodiments, the curved surface has a single grid, for example a geodesic grid, that divides the curved surface into multiple grid elements. FIG. 4 shows an example of the container module 30 implemented as a sphere with a single grid 38′.

In yet other embodiments, the container module 30 is implemented as a three-dimensional structure that includes both planar surfaces and curved surfaces. In such embodiments, some of the planar surfaces may have a generalized two-dimensional grid, and portions of the curved surface may have a grid.

In all of the aforementioned embodiments, each convergence point, at which photon emission is desired, corresponds to the intersection of the projection of two or more grid elements. Within the context of this document, the term “projection” refers to the vector that originates at the center of a grid element and extends toward the interior of the container module 30. Therefore, each convergence point corresponds to the point at which two projection vectors intersect. In the non-limiting example construction of the container module 30 depicted in FIG. 3, the projection vectors extend normal to the grid elements.

Note that for all of the aforementioned embodiments, each grid element may have a respective corresponding radiation source associated therewith. In other words, each grid element of each of the grids may have a respective radiation source (of the radiation source assembly 40) associated therewith. Therefore, each grid element may be considered to be representative of a radiation source of the radiation source assembly 40.

With continued reference to FIG. 3, each of the left-hand surface and the bottom surface of the container module 30 has a respective generalized two-dimensional grid that divides each respective surface into multiple grid elements (i.e., a first grid 38a and a second grid 38b). The first grid 38a includes a first set of grid elements that are identifiable by the markers 1-8 and A-H on orthogonal grid axes. Similarly, the second grid 38b includes a second set of grid elements that are identifiable by the markers 1-8 and I-Q on orthogonal grid axes. As should be clear from FIG. 3, the grids 38a and 38b share a common axis, and therefore share common markers 1-8. Each grid element is representative of a radiation source of the radiation source assembly 40, and the radiation sources are pairwise actuated by the control and processing subsystem 20. In the non-limiting example deployment and construction shown in FIG. 3, each of the grids 38a and 38b has 64 grid elements, resulting in a total of 128 grid elements. Therefore, the radiation source assembly 40, when deployed in the non-limiting example deployment of FIG. 3, may include 128 radiation sources (i.e., M=128).

Stimulation of molecules at two different convergence points is depicted in FIG. 3. A molecule (or molecules) 33, located at a first convergence point 34, emit(s) photons in response to stimulation from radiation emitted by one radiation source corresponding to grid element C4 and another radiation source corresponding to grid element L5. The first convergence point 34 corresponds to the intersection of the projections P_{C4} and P_{L5} of the grid elements C4 and L5, respectively. Likewise, a molecule (or molecules) 35, located at a second convergence point 36, emit(s) photons in response to radiation emitted by one radiation source corresponding to grid element E6 and another radiation source corresponding to grid element P7. The second convergence point 36 corresponds to the intersection of the projections P_{E6} and P_{P7} of the grid elements E6 and P7, respectively.

Although the radiation source assembly 40 has been described thus far as having a plurality of radiation sources, the number of which corresponds to the total number of grid elements in the grid (or grids) on the surface (or surfaces) of the container module 30, other embodiments are possible in which a single radiation source may be associated with more than one grid element. In such embodiments, the radiation sources may be attached to a motion subsystem 50, which may be implemented, for example, as a servo mechanism or the like, that provides movement (in one, two or three axes of motion) of the individual radiation sources. The control and processing subsystem 20 may be linked to such the motion subsystem 50, and may actuate the motion system to move individual radiation sources to align with between different grid elements. By utilizing a single radiation source that corresponds to multiple grid elements, the total number of individual radiation sources may be significantly reduced.

According to certain embodiments, the control and processing subsystem 20 is connected to an image modeling system 60 that executes three-dimensional (3D) image modeling software that models a 3D image that is to be produced as a real hologram by the system 10. The model of the 3D image includes pixel information corresponding to the 3D image that is to be produced as a real hologram by the system 10. The image modeling system 60 may be implemented as a computer system that includes a processing unit, for example a graphical processing unit, that includes one or more processors (e.g., hardware processors). The image modeling system 60 may be a component that is included as part of the system 10, or may be a component external to the system 10. For the purposes of illustration, the image modeling system 60 is shown in FIG. 1 as being a component included as part of the system 10. In such embodiments, the control and processing subsystem 20 receives the pixel information from the image modeling system 60 and transforms the pixel information of the 3D image model into corresponding convergence points. Each convergence point is defined by the spatial intersection of projections of respective grid elements. The control and processing subsystem 20 then sequentially actuates groups (e.g., pairs or N-tuples) of radiation sources of the radiation source assembly 40, where each group corresponds to a respective convergence point (i.e., pixel location) to produce a real hologram of the modeled image.

As discussed above, the control and processing subsystem 20 actuates the groups of individual radiation sources according to a determined actuation sequence in order to induce photon emission by molecules at a corresponding sequence of convergence points. The actuation process may be implemented according to a layered methodology, in which radiation sources 42a-42M corresponding to slices of the image are actuated in sequence in order to build-up the real hologram layer by layer. It is noted that the actuation, by the control and processing subsystem 20, of the groups of radiation sources, may be performed at a specific frequency and revisit rate of specific radiation sources, in accordance with the real hologram that is to be generated based on the image model.

Although the embodiments described thus far have pertained to generation of a real hologram having a predetermined and desired shape based on an actuation sequence according to pixel information from an image that is to be generated as the real hologram, other embodiments are possible in which the shape of the objective real hologram is predefined according to the shape of the container module 30. In such embodiments, for example, the container module 30 may be implemented as a storage vessel (or storage vessels) having a predefined geometric shape, and as a result, the emission of photons by the molecules of the compound within the container module 30 will result in a real hologram having the shape of the storage vessel(s).

According to certain embodiments, the color of the real hologram produced by the system 10 is selectable and adjustable by changing the wavelength of the radiation emitted by the radiation sources, or is selectable according to the emission spectrum of the compound (or compounds) deployed within the container module 30. For example, the compound retained in the container module 30 may have an emission spectrum in the visible light region of the electromagnetic spectrum. Accordingly, in certain embodiments, multiple compounds may be stored within the container module 30, with each compound having an emission spectrum in a different visible light region of the electromagnetic spectrum. For example, the container module 30 may store a first compound (e.g., neon gas) that has an emission spectrum in the red region of the electromagnetic spectrum (thereby emitting red light in response to stimulation by electromagnetic radiation in specific wavelengths), and a second compound (e.g., helium gas) that has an emission spectrum in the yellow region of the electromagnetic spectrum (thereby emitting yellow light in response to stimulation by electromagnetic radiation in specific wavelengths). Parenthetically, the emission spectrum of certain compounds may cover multiple visible light regions of the electromagnetic spectrum, and the light emitted in response to photon emission may be selected by adjusting the wavelength of the radiation emitted by the radiation sources.

In deployments in which multiple compounds are stored within the container module 30, the container module 30 may be advantageously implemented as one or more storage vessels, each retaining a different respective compound, as previously discussed. Alternatively, the container module 30 may be implemented as a single storage vessel, and the compounds may be selected from a group of compounds that have different densities, such that the multiple compounds do not intermix with each other when deployed within a single storage vessel.

According to certain embodiments, the plurality of radiation sources 42a-42M are implemented as an array of light sources, with each light source configured to emit radiation in the form of light in the UV, visible or infrared range of the electromagnetic spectrum. In other embodiments, the plurality of radiation sources 42a-42M are implemented as an array of laser light sources, configured to emit directed beams of laser light at selectable wavelengths.

Note that in embodiments in which the radiation sources 42a-42N are implemented as UV light sources that emit UV light, the surfaces of the container module 30 that do not have corresponding grid elements (and therefore do not have corresponding individual radiation sources) may be coated with a UV absorbing material, such as, for example, avobenzone, oxybenzone, or zinc oxide, in order to reduce the amount of UV radiation that is transmitted through the container module 30. In the non-limiting example construction of the container module 30 depicted in FIG. 3, the front and rear surfaces (in the XY-plane), the right surface (in the YZ-plane), and the top surface (in the XZ-plane) of the container module 30 may be coated with such a UV absorbing material.

The density and luminous intensity of the real holograms that can be generated by the system 10 may vary as a function of the total number of beam emitters, M, as well as the type of compound and density of the compound retained within the container module 30. In general terms, the greater the density of the compound, the higher the concentration of the energy sensitive molecules which can emit photons in response to stimulation by the radiation source assembly 40. A high concentration of energy sensitive molecules, coupled with a large value of M, can in turn yield a denser real hologram with higher luminous intensity.

Prior to operation of the system 10, a user may fill the container module 30 with a quantity of a desired compound (e.g., neon gas) via an intake valve (not shown) such that a desired quantity of the compound is retained in the container module 30. The user may perform theoretical calculations to estimate the density of the compound based on the physical properties of the compound and the size of the container module 30, or may utilize a density acquisition subsystem 70 that provides density measurements or estimates of the compound. The user should ensure that the density of the compound is high enough in order to ensure that the system 10 generates real holograms having sufficient density and luminous intensity.

The estimated or measured density of the compound, received, for example, from the density acquisition subsystem 70, may be used by the control and processing subsystem 20 to estimate the positions of the molecules of the compound, which as previously discussed, can be used by the control and processing subsystem 20 to calculate the threshold energy required to induce photon emission at different convergence points.

In certain embodiments, the density of the compound may be monitored over time via the density acquisition subsystem 70, in order to provide the system 10 with notifications in the event that the density drops below a certain level. The control and processing subsystem 20 may be configured to receive the density measurements or estimates from the density acquisition subsystem 70, and may emit a visual or audible notification if the density drops below a certain level. The density acquisition subsystem 60 may be implemented as an infrared imaging system that detects and images gas clouds and calculates the concentration of the gas cloud molecules based on the infrared image. The density acquisition subsystem 70 may be a component that is included as part of the system 10, or may be a component external to the system 10. For the purposes of illustration, the density acquisition subsystem 70 is shown in FIG. 1 as being a component included as part of the system 10.

Parenthetically, the density of the compound (or compounds), specifically in cases in which the compound is a gas, fluctuates as a function of the temperature of the environment in which the compound is deployed. In order to regulate the density of the compound(s), in certain embodiments the container module 30 is implemented as a temperature-controlled storage vessel (or storage vessels) that regulates the temperature of the volume of space within the container module 30. In one such embodiment, temperature regulation is effectuated by a temperature control subsystem 80, which includes one or more temperature sensors 82 deployed within the container module 30 for measuring an operating temperature thereof, and a temperature adjustment mechanism 84 (e.g., heating and/or cooling system) linked to the temperature sensor(s) for adjusting the operating temperature based on the temperature sensor(s) measurements. The sensor(s) 82 are linked to the control and processing subsystem 20, which analyzes the sensor measurements and actuates the temperature adjustment mechanism 84 based on the sensor measurement analysis. In a simple case, the analysis may be an evaluation of the operating temperature according to the sensor(s) measurements, and an evaluation of the operating temperature against a threshold temperature T. For example, if the operating temperature is measured to be below the threshold temperature T, the control and processing subsystem 20 may actuate the temperature adjustment mechanism 84 to heat the interior of the container module 30 until the operating temperature is measured to be within a tolerance of the threshold temperature T. Similarly, if the operating temperature is measured to be above the threshold temperature T, the control and processing subsystem 20 may actuate the temperature adjustment mechanism 84 to cool the interior of the container module 30 until the operating temperature is measured to be within a tolerance of the threshold temperature T. As should be apparent, the temperature control subsystem 80 and the control and processing subsystem 20 may cooperate to function as a closed loop system that automatically adjusts the temperature inside the container module 30.

Attention is now directed to FIG. 5, which shows a flow diagram detailing a process 500 in accordance with embodiments of the disclosed subject matter. The process 500 includes method steps for generating a real hologram in three-dimensional space within the container module 30. Reference is also made to FIGS. 1-3.

The process 500 begins at block 502, where at least one compound, having molecules that emit photons in response to stimulation by one or more beams of energy, is provided, and the container module 30 is filled with the compound.

The process 500 then moves to block 504, where the beam emitters 42a-42M (e.g., the plurality of radiation sources) are deployed in spaced relation around exterior portions of the container module 30. As discussed above, one or more surfaces of the container module 30 has a grid that divides the surface into multiple grid elements. Each respective beam emitter can be positioned in correspondence with a respective grid element.

The process 500 may then optionally move to block 506, where the control and processing subsystem 20 receives pixel information corresponding to a 3D image from the image modeling system 60. The process 500 then moves to block 508, where the control and processing subsystem 20 transforms the received pixel information into corresponding convergence points, wherein each convergence point is defined the spatial intersection of projections of respective grid elements.

The process 500 then moves to block 510, where the control and processing subsystem 20 selectively actuates groups (e.g., pairs or N-tuples) of beam emitters of the beam emitters 40, to emit directional beams of energy, where each group corresponds to a respective convergence point, in order to generate a real hologram. As discussed above, for each group, the directional beams of energy emitted by the beam emitters in the group converge at the corresponding convergence so as to induce photon emission. In embodiments in which blocks 506 and 508 are executed, the real hologram is generated based on a 3D image modeled by the image modeling system 60. In addition, in certain embodiments (as discussed above), the selective actuation of the beam emitters is performed according to an actuation sequence, i.e., the groups of the beam emitters are sequentially actuated according to the actuation sequence, wherein each group in the actuation sequence corresponds to a respective convergence point.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A system, comprising:
at least one storage vessel for retaining a quantity of at least one compound having molecules that emit photons in response to stimulation by one or more beams of energy;
a beam emitting assembly having a plurality of beam emitters, each beam emitter of the plurality of beam emitters being configured to selectively and controllably emit directional beams of energy toward the at least one storage vessel; and
a control and processing subsystem including at least one processor configured to:
selectively actuate the plurality of beam emitters in groups of at least two beam emitters, wherein, for each group, the directional beams of energy emitted by the beam emitters in the group converge at a corresponding convergence point within the at least one storage vessel so as to induce photon emission by one or more molecules of the at least one compound located at the convergence point.

2. The system of claim 1, wherein the plurality of beam emitters is implemented as a plurality of radiation sources that emit directional beams of electromagnetic radiation in one or more wavelengths of the electromagnetic spectrum.

3. The system of claim 2, wherein for each group, the directional beams of electromagnetic radiation emitted by the radiation sources in the group constructively interfere with each other at the convergence point.

4. The system of claim 1, wherein each group consists of exactly two beam emitters.

5. The system of claim 1, wherein each group includes a first beam emitter and a second beam emitter, and wherein the directional beams of energy emitted by the first and second beam emitters are substantially orthogonal to each other.

6. The system of claim 1, wherein for each group, each of the directional beams of energy emitted by the beam emitters of the group has an associated spatially variant energy, and wherein for all points other than the convergence point, the energy of each of the directional beams of energy emitted by the beam emitters of the group has a fractional amount of the energy required to induce photon emission by the one or more molecules.

7. The system of claim 1, wherein for each group, the directional beams of energy emitted by the beam emitters of the group has an associated spatially variant energy, and wherein at the convergence point, the combined energy of the directional beams of energy emitted by the beam emitters of the group is greater than or equal to the energy required to induce photon emission by the one or more molecules.

8. The system of claim 1, wherein the control and processing subsystem is further configured to actuate the beam emitting assembly in accordance with pixel information extracted from a three-dimensional image.

9. The system of claim 8, wherein the control and processing subsystem is configured to receive the three-dimensional image from an image modeling system that generates three-dimensional images.

10. The system of claim 1, wherein the at least one storage vessel includes at least one grid having a plurality of grid elements, and wherein each respective beam emitter of the plurality of beam emitters is associated with a respective grid element of the plurality of grid elements.

11. The system of claim 9, wherein the convergence point corresponds to a spatial intersection of projections of at least two of the grid elements, and wherein the control and processing subsystem is further configured to selectively actuate beam emitters associated with the at least two of the grid elements.

12. The system of claim 9, wherein the control and processing subsystem is further configured to:
transform pixels corresponding to a three-dimensional image into corresponding convergence points, wherein each convergence point is defined by the spatial intersection of projections of respective grid elements, and wherein the selective actuation includes sequentially actuating groups of beam emitters according to an actuation sequence, wherein each group in the actuation sequence corresponds to a respective convergence point.

13. The system of claim 1, wherein the at least one storage vessel is formed as polyhedron having a plurality of planar surfaces, and wherein the at least one storage vessel includes at least a first grid that divides one of the planar surfaces into a first set of grid elements and a second grid that divides another one of the planar surfaces into a second set of grid elements.

14. The system of claim 1, wherein the at least one storage vessel has at least one curved portion having a curved surface, and wherein the at least one storage vessel includes at least one grid that divides the curved surface into a set of grid elements.

15. The system of claim 1, wherein the at least one storage vessel is configured to retain a plurality of compounds, wherein each compound has an emission spectrum in a different region of the electromagnetic spectrum.

16. The system of claim 1, wherein the at least one compound includes neon gas.

17. A method, comprising:
providing a quantity of at least one compound in a storage vessel, the at least one compound having molecules that emit photons in response to stimulation by one or more beams of energy;
deploying a plurality of beam emitters in spaced relation about the exterior of the storage vessel, each beam emitter of the plurality of beam emitters configured to selectively and controllably emit directional beams of energy toward the storage vessel; and
selectively actuating the plurality of beam emitters in groups of at least two beam emitters, wherein, for each group, the directional beams of energy emitted by the beam emitters in the group converge at a corresponding convergence point within the storage vessel so as to induce photon emission by one or more molecules of the at least one compound located at the convergence point.

18. The method of claim 15, wherein the storage vessel includes at least one grid having a plurality of grid elements, and wherein each respective beam emitter of the plurality of beam emitters is associated with a respective grid element of the plurality of grid elements, and wherein the convergence point corresponds to a spatial intersection of projections of at least two of the grid elements.

19. The method of claim 16, further comprising:
receiving pixel information corresponding to a three-dimensional image; and
transforming the pixel information into corresponding convergence points, each convergence point defined by the spatial intersection of projections of respective grid elements, wherein the selective actuation includes sequentially actuating groups of beam emitters according to an actuation sequence, wherein each group in the actuation sequence corresponds to a respective convergence point.

20. A system, comprising:
at least one storage vessel for retaining a quantity of at least one compound having molecules that emit photons in response to stimulation by electromagnetic radiation in one or more wavelengths of the electromagnetic spectrum;
a radiation source assembly having a plurality of radiation sources, each radiation source of the plurality of radiation sources being configured to selectively and controllably emit directional beams of electromagnetic radiation toward the at least one storage vessel; and
a control and processing subsystem including at least one processor configured to:
selectively actuate the plurality of radiation sources in groups of at least two radiation sources, wherein, for each group, the directional beams of electromagnetic radiation emitted by the radiation sources in the group constructively interfere with each other at a corresponding convergence point within the at least one storage vessel so as to induce photon emission by one or more molecules of the at least one compound located at the convergence point.
